(19) United States
(12) Patent Application Publication
(10) Pub. No.: US 2025/0036466 A1
(43) Pub. Date: Jan. 30, 2025

(54) COMPUTER IMPLEMENTED METHOD FOR ORGANIZING ACCESS TO A SHARED MEMORY OF A VEHICLE

(71) Applicants: CARIAD SE, Wolfsburg (DE); VOLKSWAGEN AKTIENGESELLSCHAFT, Wolfsburg (DE)

(72) Inventors: Giovanni GROSSETTI, Bochum (DE); Stefan BRIESE, Bochum (DE); Emmanuel Veranyuy MFON, Bochum (DE); Marcel SCHWEGLER, Bochum (DE); Serdal UZUN, Bochum (DE); Wolfgang THEIMER, Bochum (DE); Bhushan JOSHI, Wolfsburg (DE)

(21) Appl. No.: 18/713,125

(22) PCT Filed: Nov. 24, 2021
(86) PCT No.: PCT/EP2021/082882

§ 371 Date: May 23, 2024

(51) Int. Cl. G06F 9/50; G06F 9/54

(52) U.S. Cl. CPC G06F 9/5016; G06F 9/544

(57) ABSTRACT

The disclosure is concerned with a computer implemented method for organizing access to a shared memory of a vehicle. Each of a plurality of vehicle functions of the vehicle is configured to execute an application in a corresponding one of a plurality of memory portions of the shared memory. The method includes, for each vehicle function of the vehicle functions: registering the vehicle function for a memory allocation service; determining a location and a size of the corresponding one of the memory portions of the shared memory for the vehicle function by applying an allocation; algorithm; executing the application of the vehicle function on the corresponding one of the memory portions; and after the executing, disconnecting the vehicle function from the memory allocation service. The applied allocation algorithm allocates dynamically the corresponding one of the memory portion portions.

### BACKGROUND

### Technical Field

The disclosure is concerned with a computer implemented method for organizing access to a shared memory of a vehicle. The disclosure is furthermore concerned with a vehicle, a computer program product and a processing device configured to provide such a method.

### Description of the Related Art

A vehicle typically provides multiple vehicle functions, such as a driver assistance system and/or a sensor of the vehicle configured to provide sensor data. In order to execute an application of such a vehicle function of the vehicle, it is often necessary for the vehicle function to store data on a memory device and/or to access data stored on the memory device.

### BRIEF SUMMARY

It is the object of the disclosure to provide well-organized access to a memory of a vehicle.

Advantageous embodiments of the disclosure are specified in the following description, the claims, and the figures.

A first aspect of the disclosure is concerned with a computer implemented method for organizing access to a shared memory of a vehicle. Multiple vehicle functions of the vehicle are each configured to execute an application in a memory portion of the shared memory. The shared memory is preferably a centralized storage unit of the vehicle. The multiple vehicle functions are for example, at least one driver assistance system, at least one sensor providing sensor data, a remote locking and unlocking function of the vehicle, a connection service to an external device to, for example, stream music in the vehicle and/or an air conditioning system of the vehicle. All these vehicle functions are based on a software. The respective may be carried out by a processing device of the vehicle. The processing device may comprise the multiple vehicle functions and/or at least one of the multiple vehicle functions.

The application of the vehicle function is, for example, the function provided by the vehicle function. This mean that, for example, in case of a driver assistance system as a vehicle function the application may comprise generating operating commands for the vehicle to provide the driver assistance system. In case of a lane assist as a vehicle function, the application may generate operating commands for the vehicle, more precisely for a steering system of the vehicle, so that when the generated operating command is executed by, for example, a control unit of the vehicle, the vehicle is guided along a current lane. In case of a sensor as a vehicle function, data collection or capturing by the sensor can be the application of this vehicle function. The captured sensor data provided by the sensor are stored in a memory portion of the shared memory. The application can hence be understood as a storing function of the collected or captured data by the sensor. In case of the connection service to stream music as a vehicle function, the application might be providing the communication connection to an external server unit that provides the music. The software and/or a setting required to provide the communication connection may be stored in the shared memory. In other words, there are preferably multiple different applications of the vehicle that require access and preferably reading and/or writing rights for the shared memory.

To prevent that each vehicle function choses a random and possibly overlapping part of the shared memory to, for example, write data to the shared memory, a portion of the shared memory is preferably assigned to each vehicle function and particularly to each application of each vehicle function. There is preferably only one memory for all vehicle functions which is the shared memory. In other words, the shared memory is a memory that may be simultaneously accessed by multiple computer programs, meaning by multiple applications.

The computer implemented method comprises the following steps for each of the vehicle functions: registering the vehicle function for a memory allocation service; determining a location and size of the memory portion of the shared memory for the registered vehicle function by applying an allocation algorithm; executing the application of the vehicle function on the determined memory portion; after execution, disconnecting the vehicle function from the memory allocation service. In other words, the vehicle function requests the memory portion of the shared memory. The memory allocation service is, in other words, a computer program that receives and processes the request of the vehicle function, wherein the vehicle function requests allocation of a memory portion of the shared memory.

The allocation algorithm comprises, for example, instructions which, when executed by a computer, allow, for example, to determine and/or define the memory portion of the shared memory. Defining of the memory portion comprises determining the location and the size of the memory portion. The memory portion is, in other words, an allocated memory section of the shared memory. The location of the memory portion may be its address on the shared memory. The location can be any chosen location on the shared memory. The size of the memory portion may be an amount of memory assigned to the application and/or the vehicle function. The size of a memory portion depends typically on the vehicle function itself, more precisely on its application. The allocation algorithm can, for example, consider negotiations of two vehicle functions which try to execute the application simultaneously. If, for example, the vehicle provides a broker, meaning a computer program that is configured to allocate the memory portion of the shared memory to each vehicle function, the allocation algorithm is preferably executed by the broker so that the broker determines the location and size of the memory portion of the shared memory for each of the currently registered vehicle functions.

Executing the application means running the application. For example, the sensor as a vehicle function writes sensor data captured or collected by the sensor to the determined memory portion of the shared memory while being executed. The sensor may be a front camera, a rear camera, a side camera, a Lidar device, an infrared sensor, a velocity sensor, an accelerations sensor, a temperature sensor and/or any other sensor device of the vehicle. The driver assistance system as a vehicle function, for example, reads the sensor data provided by the sensor and/or writes data to its memory portion of the shared memory while being executed. In case the vehicle function comprises multiple applications, each application may be executed. Preferably, the allocation algorithm determines an individual memory portion for each application of the multiple applications of the vehicle function.

In the last described step, the memory allocation service is disconnected. In other words, the memory allocation service is terminated, meaning that the vehicle function locks-off from the memory allocation service after the application of the vehicle function has been executed. Afterwards, the described process may be closed, meaning that the computer implemented method is terminated.

The disclosure is based on the observation that existing shared memory concepts typically do not provide a dynamic framework for multiple clients, meaning for multiple requesting vehicle functions, to provide and/or subscribe to various data sources with a sufficient management interface. However, the shared memory concept may be improved by allocating the memory portion of the shared memory dynamically.

The applied allocation algorithm hence allocates dynamically the memory portion. Dynamic allocation means that an amount of shared memory allocated to a vehicle function can change dependent on the vehicle function itself. In other words, the amount of shared memory is not necessarily a compile-time constant. In other words, the vehicle is a dynamic shared memory. The advantage of the dynamic allocation is an improved organization of access to the shared memory of the vehicle.

An embodiment comprises that all vehicle functions are configured to send a request concerning the shared memory. In other words, each vehicle function can act as a client. The client is configured to, for example, request data that is stored on a memory portion of the shared memory. Alternatively or additionally, the client can write data to the memory portion of the shared memory. If the sensor as a vehicle function acts a client, it requests an allocated memory portion so that it can write its captured sensor data to its memory portion of the shared memory. This means that at least one possible role is dedicated to each vehicle function which can be the role of the client. In the following, the expression “client” is used to describe a vehicle function that is configured to send a request concerning the shared memory.

In an additional embodiment, at least one of the vehicle functions is configured to allocate the memory portion by applying the allocation algorithm. This means that the at least one vehicle function can act as a daemon. A daemon is a computer program that runs as a background process. The daemon can provide a service such as the memory allocation service. This means that the vehicle function that acts as the daemon can allocates the memory portion for itself but as well for at least one other vehicle function. The vehicle function that acts as the daemon comprises software and/or instructions which, when executed by a computer, provide the allocation algorithm. In other words, the at least one vehicle function that is configured to allocate the memory portion is the vehicle function that determines the location and size of the memory portion of the shared memory for preferably all registered vehicle functions. In the following, the expression “daemon” is used to describe a vehicle function that is configured to allocate the memory portion by applying the allocation algorithm.

If, for example, a first vehicle function acts both as a client and as a daemon, while a second vehicle function, which registers simultaneously for the memory allocation service, acts only as a client, the first vehicle function provides the memory portion allocation for the second vehicle function so that the first vehicle function alone determines for both vehicle functions the location and size of the respective memory portion of the shared memory. The first vehicle function may be referred to as first process and the second vehicle function as second process. In other words, the vehicle function that can be both a client as well as a daemon determines the location and size of the memory portion 5 of the shared memory for all vehicle functions, even for those that are not configured as a daemon but only as client. Such an implementation of a shared memory in a vehicle can alternatively be referred to as hybrid distributed dynamic shared memory concept. As no additional broker is required to provide the memory allocation service, this is a particularly reasonable way to organize access to the shared memory.

According to another embodiment, only the at least one vehicle function configured to allocate the memory portion provides a full shared memory implementation. In other words, only the vehicle functions that can act as daemons provide a complete shared memory implementation. All vehicle functions that are only configured to send the request concerning the shared memory, meaning all vehicle function that act only as clients, do not provide a full shared memory implementation. A full implementation comprises that the respective vehicle function is configured to negotiate the allocation of memory portions between multiple vehicle functions that request simultaneously the memory allocation service. This enables scalability of the organization of access to the shared memory without an extensive growth of required connections within the vehicle.

Particularly, related vehicle functions may be grouped around different vehicle functions acting as daemons to save extra resources. Alternatively or additionally, related vehicle functions may be grouped around a common daemon, meaning around a common vehicle function that may also act as daemon. Related vehicle functions are, for example, vehicle functions of a common kind or type of vehicle function. For example, different sensors of the vehicle that are configured to monitor the environment of the vehicle as vehicle functions may be related vehicle functions and/or driver assistance systems as vehicle functions may as well be related to one another. If the related vehicle functions are grouped around different daemons, the memory allocation service for each vehicle function of the related vehicle functions is provided by an individual daemon. Hence, no two related vehicle functions share a common daemon. If the related vehicle functions are grouped around a common daemon, one of the related vehicle functions acts as daemon for itself and for all other related vehicle functions. Preferably, multiple vehicle functions are configured to act both as client and as daemon.

Another embodiment comprises that the vehicle function configured only to send the request registers for the memory allocation service with the vehicle function configured to allocate the memory portion. This means a vehicle function that can act only as a client sends its registering for the memory allocation service directly to the vehicle function that acts as the daemon. The method hence comprises registering the vehicle function that acts as the daemon as well as at least one vehicle function that acts as a client only for the memory allocation service, wherein the memory allocation service is provided by the vehicle function that acts as the daemon. In another step, the location and the size of the memory portion of the shared memory for the vehicle function that acts only as a client is determined by the vehicle function that acts as the daemon. It also determines the location and size of its own memory portion on the shared memory. This means that one of the two vehicle functions determines the shared memory portions for both vehicle functions. The vehicle function that acts as the daemon provides information representing at least the determined location and size of the memory portion for the vehicle function that acts only as a client. Both vehicle functions can then execute their applications on the determined memory portions. Afterwards, the vehicle function that acts as a client only sends a disconnecting signal to the vehicle function that acts as the daemon to disconnect the vehicle function that acts as a client only from the memory allocation service. The vehicle function that acts as the daemon may disconnect itself from the memory allocation service and hence, for example, withdraw from the described method so that, for example, another vehicle function that can act as a daemon, may take over the daemon role. Preferably, the role of the daemon is only a temporary function of the vehicle function. In case of simultaneously active vehicle functions, the negotiations for an allocated memory portion between the active vehicle functions are organized efficiently due to a clear distribution of roles between the active vehicle functions.

So far, the hybrid distributed dynamic shared memory concept was presented. Possible advantages of this concept are: Features of a daemon and a client are merged in individual vehicle functions without extensive growth of connection links between the vehicle functions; not every vehicle function needs a full shared memory implementation; relating processes, meaning related vehicle functions, can be grouped around different other vehicle functions that can act as daemons; no extra process is required for managing the shared memory because the daemon role is comprised by individual vehicle functions.

An additional embodiment comprises that all vehicle functions are configured to allocate the memory portion. The vehicle functions all provide a full shared memory-implementation. This concept can be referred to as distributed dynamic shared memory concept. In other words, each vehicle function provided in this embodiment can act both as a client as well as a daemon. This means that each vehicle function is fully implemented in the shared memory.

An advantage of this embodiment is that there overhead communication is reduced. Overhead is, for example, data, particularly representing additional information regarding transmittance and/or storage of data. As all vehicle functions may act as daemons, less overhead communication is necessary compared to daemon communication.

More precisely, only one vehicle function of the multiple vehicle functions actually acts as daemon but every vehicle function is able to act as daemon. Therefore, it is useful to decide which of the multiple vehicle functions actually takes over the role of the daemon.

Therefore, according to an embodiment, the method comprises, if multiple vehicle functions are registered simultaneously and each of them is configured to allocate the memory portion, applying a prioritizing algorithm to determine a single dominating vehicle function that applies the allocation algorithm. The prioritizing algorithm comprises preferably instructions to decide which vehicle function acts as the daemon. The prioritizing algorithm may be applied in any situation in which two vehicle functions that can act as daemon register simultaneously for the memory allocation service. The prioritizing algorithm is applicable to both the hybrid distributed dynamic shared memory concept and the distributed dynamic shared memory concept. The prioritizing algorithm can comprise, for example, a list of all vehicle functions of the vehicle ranked in order of, for example, importance. For example, the first vehicle function out of this list is chosen automatically as dominating vehicle function, if it is currently registered for the memory allocation service. If the first vehicle function of the list is currently not registering for the memory allocation service, the vehicle function that is highest in the list and currently registered for the memory allocation service is determined as dominating vehicle function. Therefore, a clear hierarchy is provided according to which the vehicle function that has to act as a daemon for all or at least a part of the registered vehicle functions can be chosen.

Particularly, in case of the distributed dynamic shared memory concept according to which all vehicle functions are configured to allocate the memory portion no additional centralized daemon process is necessary because all vehicle functions can provide the daemon function. Therefore, resources can be saved.

According to another embodiment regarding the prioritizing algorithm, the prioritizing algorithm comprises a ranking of the multiple vehicle functions, starting with the vehicle function most relevant for vehicle safety and/or security. This means vehicle functions particularly relevant are predefined. If, for example, two vehicle functions are registered that can both act as daemon of which one is safety-relevant and/or security-relevant and the other one is not, the safety-relevant and/or security-relevant vehicle function is the dominating vehicle function. The safety-relevant and/or security-relevant vehicle function may be a front camera of the vehicle whereas the vehicle function providing the communication connection to stream music is not considered safety-relevant and/or security-relevant. In this example, the vehicle function of the front camera is ranked higher than the other vehicle function. This is based on the observation that especially front camera data is particularly important to provide, for example, a safety-relevant and/or security-relevant emergency stop system of the vehicle that is based, for example, on obstacle recognition derived from the camera data. On the other hand, the communication connection for streaming music has little impact on safety and security of the vehicle, particularly the passengers of the vehicle, so that in this example the vehicle function of the front camera will act as daemon whereas the vehicle function regarding the communication connection to stream music acts as a client only. Therefore, hierarchy of vehicle functions is well defined and hence a centrally organized access to the shared memory is provided easily.

Besides, an embodiment comprises that the ranking ends with at least one vehicle function that is a pure convenience function. Such a function that is a pure convenience function is, for example, the vehicle function that provides the communication connection to the external device for streaming music. This is because the convenience function is defined as a function that only provides comfort for, for example, a passenger of the vehicle but has no significant and/or recognizable effect on vehicle safety and/or security. Alternatively, the convenience function may have only small impact on safety and/or security of the vehicle. The convenience function is a function mainly or even completely configured for convenience of the passenger of the vehicle. In other words, the vehicle functions may be ranked according to safety and/or security and their relation to convenience and comfort, whereas convenience and comfort is ranked lower than safety and/or security. This allows for a particularly optimized prioritization and determination of the dominating vehicle function.

Furthermore, an embodiment comprises a centralized software separated from the vehicle functions. The centralized software applies the allocation algorithm. The centralized software may be a centralized daemon. The centralized software may be an application of software running on an electronic control unit. A common device can execute the centralized software and at least one of the multiple vehicle functions. The common device may be, example, the processing device of the vehicle and/or the electronic control unit.

In this embodiment, the shared memory is governed by the central unit, meaning the centralized software, which allows for abstraction for shared memory logic for vehicle functions that, for example, only act as clients.

According to another embodiment, the centralized software determines non-continuous locations of the determined memory portions. This shared memory concept may be referred to as centralized dynamic shared memory concept. According to this concept, individual applications may abstract data in modular access controllable units. No explicit memory management is necessary and therefore each vehicle function may have its own dynamic shared memory region, meaning its own dynamic memory portion of the shared memory. The vehicle function only accesses the shared memory via permission limited references provided by the centralized software. In other words, the shared memory is hidden in the centralized software that acts as daemon. There is hence one centralized daemon for all vehicle functions of the vehicle that is configured to divide the shared memory into multiple memory portions that are not necessarily connected to one another. The memory portion may be referred to as shared memory block or shared memory region. The individual memory portions are preferably individual entities. Between the individual memory portions gaps in memory may remain. As an advantage, each application of the vehicle function may have its own dynamic shared memory portion determined by only one the centralized software.

An alternative embodiment comprises that the centralized software determines continuous locations of the determined memory portions. This shared memory concept may be referred to as statically allocated dynamic resizable shared memory concept. According to this concept, full low-level control of the memory portions is provided. The centralized software may determine a first memory portion for a first vehicle function and allocates a second memory portion for a second vehicle function directly next to the first memory portion. The first and second memory portion are thus located adjacent to each other. Hence, there is no gap between the different memory portions. This means that shared memory is filled up continuously with memory portions for different vehicle functions and/or applications of vehicle functions according to a timeline in which they register for the memory allocation service. The advantage of this concept is, for example, the full low-level control of memory portions.

Another embodiment comprises that the size of the determined memory portion is determined dynamically based on the respective vehicle function. This means that there is always enough amount of memory provided for each vehicle function. In particular, the application and/or particularly multiple applications of each vehicle function are all considered. The centralized software hence always chooses the size of the memory portion according to the application and/or the applications of the respective vehicle function. This means that, for example, the sensor data provided by a sensor as a vehicle function is allocated to a memory portion that fits in size the expected amount of sensor data. It is hence possible that, for example, a camera of the vehicle as a vehicle function receives a larger size of allocated memory portion compared to a temperature sensor. The size of the memory portion is hence determined proactively.

Besides, an embodiment comprises removing the allocation to the determined memory portion of the shared memory after disconnecting the vehicle function from the memory allocation service. Removing the allocation to the determined memory portion is in other words releasing the determined memory portion of the shared memory for further vehicle functions. This means that the location and size of the memory portion is now available for, for example, another vehicle function that registers for the memory allocation service. There is hence typically always enough space on the shared memory for all currently registered vehicle functions because the vehicle functions which are already disconnected from the memory allocation service are not allocated to their determined memory portions anymore due to the removing of the allocation.

According to another embodiment, the method comprises erasing all data stored in the memory portion. In other words, a clean-up is performed, preferably after disconnecting the vehicle function from the memory allocation service as well as after removing the allocation to the determined memory portion of the shared memory. The erasing of the data is not necessarily automatic. It is possible to set a time interval, for example of 5 minutes, starting preferably at the end of execution of the application of the vehicle function. After the time interval, all data stored in the memory portion of the vehicle function are deleted automatically. It is, for example, possible to erase camera data of the front camera of the vehicle every 5 minutes after its capture automatically. Alternatively or additionally, the data can be erased directly after disconnecting and/or, as described above, after removing the allocation for the vehicle function. Therefore, memory space is generated easily and quickly for a further vehicle function.

Another aspect of the disclosure is concerned with a vehicle. The vehicle may be a motor vehicle, such as a passenger vehicle, a truck, a bus and/or a motorcycle. The vehicle comprises a shared memory. The vehicle is configured to carry out the above-described method.

Another aspect of the disclosure is concerned with a non-transitory computer-readable medium. The computer readable medium stores a computer program. The computer program product is stored in a storage unit or data storage of, for example, a processing device of a vehicle. The vehicle comprises a shared memory. The computer program product comprises instructions which, when the program is executed by, for example, the processing device or by a computer, cause the processing device or the computer, respectively, to carry out the method as described above.

Another aspect comprises a processing device configured to carry out the described method. The processing device may be a processor. The processing device may comprise at least one microcontroller and/or microprocessor. The processing device may comprise program code that is designed to perform the method when executed by the processing device. The program code may be stored in a data storage of the processing unit.

An embodiment or a combination of embodiments of the above-described method are considered as an embodiment of the inventive vehicle, the inventive computer program product as well as the inventive processing device, if applicable.

The disclosure also comprises embodiments that provide features which afford additional technical advantages.

The disclosure also comprises the combinations of the features of the different embodiments.

### BRIEF DESCRIPTION OF THE SEVERAL VIEWS OF THE DRAWINGS

In the following an exemplary implementation of the disclosure is described.

FIG. 1 shows a schematic representation of a vehicle with a shared memory and multiple vehicle functions;

FIG. 2 shows a schematic representation of a computer implemented method for organizing access to a shared memory of a vehicle;

FIG. 3 shows a schematic representation of a hybrid distributed dynamic shared memory concept;

FIG. 4 shows a schematic representation of a distributed dynamic shared memory concept;

FIG. 5 shows a schematic representation of a centralized dynamic shared memory concept; and

FIG. 6 shows a schematic representation of a statically allocated dynamic resizable shared memory concept.

### DETAILED DESCRIPTION

The embodiment explained in the following is an advantageous embodiment of the disclosure. However, in the embodiment, the described components of the embodiment each represent individual features of the disclosure which are to be considered independently of each other and which each develop the disclosure also independently of each other and thereby are also to be regarded as a component of the disclosure in individual manner or in another than the shown combination. Furthermore, the described embodiment can also be supplemented by further features of the disclosure already described.

In the figures identical reference signs indicate elements that provide the same function.

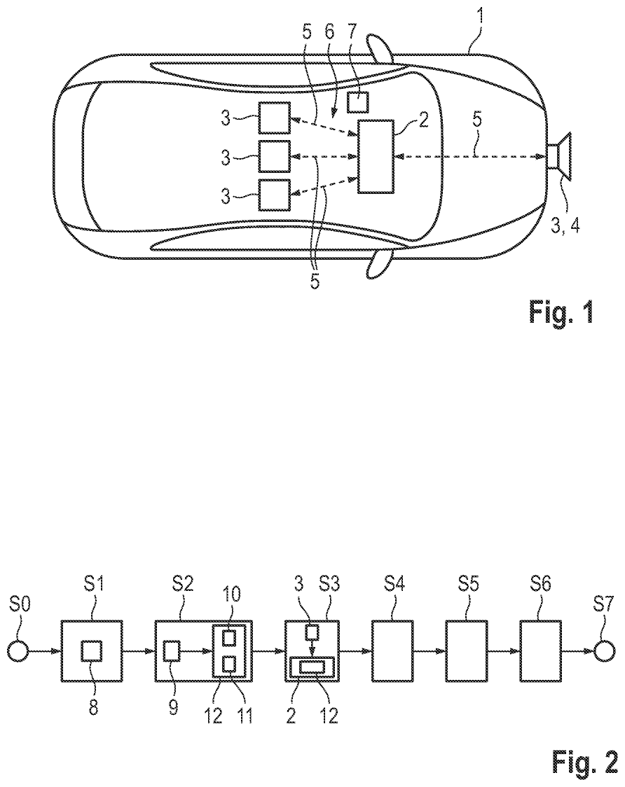

FIG. 1 shows a vehicle 1 that comprises a shared memory 2. The shared memory 2 is a centralized storage unit. To the shared memory 2, for example, sensor data and/or program code for a function of the vehicle 1 may be stored. The vehicle 1 furthermore comprises multiple vehicle functions 3. The multiple vehicle function 3 are functions of the vehicle 1. The vehicle function 3 may be a driver assistance system, such as a lane assist, a sensor device or sensor of the vehicle 1, a remote locking and unlocking function of the vehicle 1, an air conditioning system of the vehicle 1 and/or a communication connection to an external device via which music streaming is possible. Each vehicle function 3 comprises, for example, instructions that provide the respective function. The vehicle function 3 can be referred to as a process.

In this example, four possible vehicle functions 3 are sketched of which one is a sensor, in this example a front camera 4 of the vehicle 1. The front camera 4 can collect or capture sensor data that is stored on the shared memory 2. The other the vehicle functions 3 may be the lane assist, the remote locking and unlocking function and the function to provide streaming of music. The named vehicle functions 3 are purely illustrative. Less (for example only two) or more and/or other vehicle functions 3 are possible.

Each vehicle function 3 is configured to execute an application in the shared memory. Therefore, data transmission 5 between each vehicle function 3 and the shared memory 2 is provided. This data transmission 5 is sketched with two headed arrows in FIG. 1.

The vehicle 1 comprises a processing device 6, which may be a processor and/or a combination of multiple processors. The processing device 6 may comprise at least one microcontroller and/or microprocessor. The processing device 6 can alternatively be referred to as a computer of the vehicle 1. The shared memory 2 as well as the vehicle functions 3 may be comprised by the processing device 6. The processing device 6 may provide a storage unit 7. The storage unit 7 is alternatively only a component of the vehicle 1 and not of the processing device 6. In the storage unit 7 a computer program product is stored. The computer program product is a computer program and hence comprises program code to be carried out by the processing device 6.

FIG. 2 shows different steps of the computer implemented method to organize access to the shared memory 2 of the vehicle 1. The method comprises the following steps for each of the vehicle functions 3: In a step S0, the vehicle function 3 requests execution of at least one application of the vehicle function 3. Step S0 is hence a starting point of the method. A step S1 comprises registering of the vehicle function 3 for a memory allocation service 8. The memory allocation service 8 is a service with thee purpose to provide, for example, a section of the shared memory 2 for the vehicle function 3, so that the vehicle function 3 can, for example, write data to that section and/or read data from that section of the shared memory 2. The section of the shared memory 2 is referred to as memory portion 12 of the shared memory 2.

In a step S2, an allocation algorithm 9 is applied in order to determine a location 10 and a size 11 of the memory portion 12 of the shared memory 2. This memory portion 12 is allocated to the registered vehicle function 3. The allocation algorithm 9 comprises instructions that allow to determine the location 10 and the size 11 of the memory portion 12.

In a step S3, the method comprises executing the application of the vehicle function 3 on the determined memory portion 12. In other words, the application of the vehicle function 3 is actually run. In case of the front camera 4 as a vehicle function 3, for example, captured sensor data of the front camera 4 are stored in the determined memory portion 12 when the application of the front camera 4 as a vehicle function 3 is executed.

Another step S4, which is preferably performed after execution of the application of the vehicle function 3 in step S3, comprises disconnecting the vehicle function 3 from the memory allocation service 8. This means that after the application was performed, the memory allocation service 8 is no longer needed so that the respective vehicle function 3 signs off from this memory allocation service 8.

A step S5 comprises removing the allocation from the determined memory portion 12 of the shared memory 2. In other words, the allocation, meaning the determined location 10 and the size 11 of the memory portion 12, is no longer allocated to the respective vehicle function 3. In a step S6, the method comprises erasing all data stored in the memory portion 12. In other words, a clean up of the used memory portion 12 is performed. Afterwards, in a step S7 the described method is terminated.

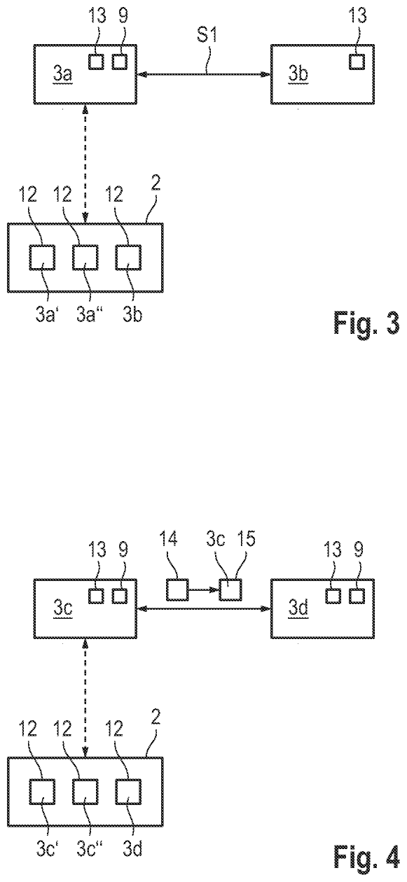

FIG. 3 shows a particular embodiment of the so-far described computer implemented method. This concept is referred to as hybrid distributed dynamic shared memory concept. This as well as the following shared memory concepts are all based on the fact that the applied allocation algorithm 9 allocates dynamically the memory portion 12. This means that the amount of memory per memory portion 12 can change from launch to launch of the method so that the size 11 of the memory portion 12 is not necessary compile-time constant but preferably depends on the vehicle function 3 and particularly the application of the vehicle function 3.

In FIG. 3, two different vehicle functions 3 are shown exemplarily which are referred to as a vehicle function 3a and a vehicle function 3b. In this example, both vehicle functions 3a, 3b are vehicle functions 3 configured to send a request 13 concerning the shared memory 2. This means that these two vehicle functions 3a, 3b can both act as a client. The vehicle function 3a can be the front camera 4 collecting data that is supposed to be stored on the determined memory portion 12. The vehicle function 3b may be a lane assist as driver assistance system that requests to, for example, read sensor data provided by the front camera 4 from the memory portion 12 of the shared memory 2. The described vehicle functions 3a, 3b are purely illustrative and are hence only one of multiple possible examples. Besides, every possible vehicle functions 3 of the vehicle I can be regarded as alternative vehicle functions 3a, 3b. This applies as well to all vehicle function 3 described in the following, which are the vehicle functions 3c, 3d, 3e, 3f, 3g and 3h.

Out of the two vehicle functions 3a, 3b, the vehicle function 3a is as well configured to allocate the memory portion 12 by applying the allocation algorithm 8. This means that the vehicle function 3a may act as a daemon. In other words, the vehicle function 3a can perform the above-described step S2 of the method. In this example, the vehicle function 3b is configured only to act as a client. In step S1 the vehicle function 3b hence registers to the vehicle function 3a. The vehicle function 3a that is configured to allocate the memory portion 12 provides a full shared memory implementation. This means that the vehicle function 3a determines the location 10 and size 11 of the memory portion 12 for the vehicle function 3a as well as the location 10 and size 11 of the memory portion 12 for the vehicle function 3b.

In this example, the vehicle function 3a comprises two different applications. Therefore, vehicle function 3a is split up into vehicle function 3a′ and vehicle function 3a″. The two different applications are, for example, capturing camera data and providing obstacle data, preferably determined based on the captured sensor data by applying methods of digital imaging on the captured sensor data. The obstacle data may represent at least one obstacle in the environment of the vehicle 1 such as another vehicle 1 and/or a pedestrian crossing the road on which the vehicle 1 is driving. In this example, vehicle function 3b comprises only one application. For all applications, a respective memory portion 12 may be determined.

FIG. 4 shows another embodiment of the inventive method that comprises a distributed dynamic shared memory concept. According to this concept, all vehicle functions 3, in this example the vehicle functions 3c and 3d, are both configured to allocate the memory portion 12 and are hence both able to apply the allocation algorithm 9. Both vehicle functions 3c and 3d are hence possible daemons. Both vehicle functions 3c, 3d may act as clients as well, meaning they can send the request 13 concerning the shared memory 12. In this embodiment, it is first to be determined which one of the vehicle functions 3c, 3d actually acts as the daemon performing step S2 of the described method. This example is based on the assumption that both vehicle functions 3c, 3d register simultaneously for the memory allocation service 8.

First, a prioritizing algorithm 14 can be applied in order to determine a single dominating vehicle function 15 that applies the allocation algorithm 9. In other words, the vehicle function 3 that actually acts as the daemon is the dominating vehicle function 15. In this example, the dominating vehicle function 15 is vehicle function 3c. The prioritizing algorithm 14 comprises a ranking of the multiple vehicle functions 3 starting with the vehicle functions 3 most relevant for vehicle safety and/or security and ending with at least one vehicle function 3 that is a pure convenience function. If the vehicle function 3c is, for example, the front camera 4 of the vehicle whereas the vehicle function 3d is the communication connection to the external device for streaming music, the vehicle function 3d is a pure convenience function whereas the vehicle function 3c is most likely important for vehicle safety and/or security. In this example, the vehicle function 3c is chosen as the dominating vehicle function 15. Therefore, the vehicle function 3d acts as daemon and determines the respective location 10 and size 11 of the memory portions 12 for all applications of the vehicle functions 3c and 3d. In this example, there are again two applications for the vehicle function 3c, which are referred to as vehicle functions 3c′, 3c″ (analogous to vehicle functions 3a′ and 3a″).

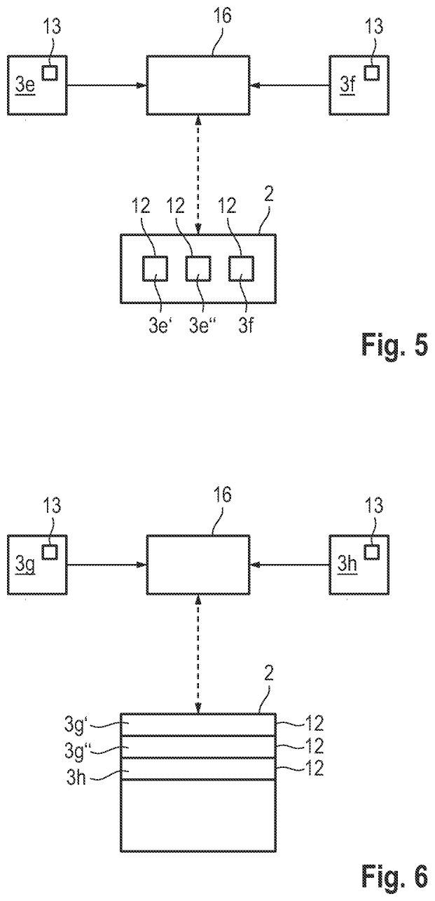

FIG. 5 shows another embodiment of the method that represents a centralized dynamic shared memory concept. This concept is based on a centralized software 16 that is separate from the vehicle function 3 and configured to apply the allocation algorithm 8. The two sketched vehicle functions 3e and 3f may be vehicle functions 3 configured only to send the request 13 concerning the shared memory 2. The vehicle functions 3e, 3f hence only act as clients. The vehicle function 3e is split up into vehicle function 3e′ and vehicle function 3e″. The centralized software 16 determines non-continuous locations 10 of the determined memory portions 12. This means that there might be gaps on the shared memory 2 between the individual memory portions 12. Vehicle functions 3e and 3f may be analogous to vehicle functions 3a and 3b or 3c and 3d.

FIG. 6 shows another embodiment of the method providing a statically allocated dynamic resizable shared memory concept. According to this concept, the centralized software 16 determines continuous locations 10 of the determined memory portion 12. This means that there are no gaps in between the determined memory portions 12. Therefore, for example, the size of the determined memory portion 12 is first determine dynamically based on the respective vehicle function 3 and particularly the application of the vehicle function 3 so that the memory portions 12 of the determined sizes 11 are determined as adjacent memory portions 12 of the shared memory 2.

The vehicle functions 3g and 3h of this embodiment may be analogous to vehicle functions 3a and 3b or 3c and 3d or 3e and 3f. The vehicle function 3g is split up into vehicle function 3g′ and vehicle function 3g″.

In the embodiments shown in FIGS. 3, 4, 5 and 6, it is always assumed that one of the two vehicle functions 3 comprises two applications whereas the other one comprises only one application. This is however just an example, meaning that each of the shown vehicle functions 3, meaning each of the vehicle functions 3a to 3h, might comprise multiple applications or only one application.

Overall, the examples show that the computer implemented method is based on sharing of the centralized shared memory 2 to which, for example applications of the vehicle functions 3 can rely on in order to run themselves.

Each vehicle function 3 wishes to use one of the available services, meaning requires a location of the memory portion 12 on the shared memory 2. By doing this, negotiating the usage and the amount of the memory portion 12 is performed by a centralized instance which is typically the vehicle function 3 that is configured to allocate the memory portion 12 by applying the allocation algorithm 9. Once the vehicle function 3 or more precisely its application has completed its task, the memory portion 12 is freed again for further usage by other vehicle functions 3. The four concepts presented provide main advantages, which are: less communication overhead than daemon; the daemon process is not necessary which saves resources; the vehicle function 3 can take either a dedicated role such as the role of a client that requests to read and/or writes data to the shared memory 2. Multiple vehicle distributed shared memory servers can be set up easily thus allowing scalability of resources.

Currently there are different possible embodiments which are presented here, meaning the four different concepts. In FIG. 3, it is shown that vehicle functions 3a, 3b can act both as client and as daemon. This implies that they are entitled to negotiate and allocate the memory portion 12 upon request of other vehicle functions 3. The concept is called hybrid distributed dynamic shared memory concept. It is worth noting that this concept allows scalability without an extensive growth of required connections. In addition, not every vehicle function 3 needs a full shared memory implementation, and relating vehicle functions 3 may be grouped around different daemon processes to save extra resources. Finally, no extra vehicle function 3 is required for managing the shared memory 2.

In FIG. 5, the centralized dynamic shared memory concept is shown. Here, a central unit as a daemon governs the shared memory 2. The central unit is referred to as centralized software 16. The centralized software 16 provides an abstraction of shared memory logic for vehicle functions 3, which can be both server and client vehicle functions 3. The server function is a vehicle function 3 that only reads data meaning that is receives data from the shared memory 12. Such a vehicle function 3 might be the lane assist as driver assistance system. In the framework, the vehicle function 3 that acts as server may abstract data in modular access controllable units. The vehicle function 3 only accesses the shared memory 2 via permission limited references. No explicit memory management is necessary and therefore each vehicle function 3 has its own dynamic shared memory region, meaning its own memory portion 12.

The distributed dynamic shared memory concept shown in FIG. 4 provides less communication overheads compared to communication necessary if a daemon is provided by the vehicle function 3 or multiple vehicle functions 3. In this way resources can be spared. The statically allocated dynamic resizable shared memory concept in FIG. 6 allows low level control of shared memory regions, meaning of memory portions 12, but possibly causes fragmentation when resizing what has been implemented.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A computer implemented method for organizing access to a shared memory of a vehicle, wherein each of a plurality of vehicle functions of the vehicle is configured to execute a corresponding one of a plurality of applications in a corresponding one of a plurality of memory portions of the shared memory, wherein the method comprises:
for each vehicle function of the vehicle functions:
registering the vehicle function for a memory allocation service;
determining a location and a size of the corresponding one of the memory portions of the shared memory for the vehicle function by applying an allocation algorithm;
executing the corresponding one of the application of the vehicle function on the corresponding one of the memory portions; and
after the executing, disconnecting the vehicle function from the memory allocation service;
wherein the allocation algorithm allocates dynamically the corresponding one of the memory portions.

2. The method according to claim 1, wherein all of the vehicle functions are configured to send a request concerning the shared memory.

3. The method according to claim 2, wherein at least two of the vehicle functions are configured to allocate the corresponding one of the memory portions by applying the allocation algorithm.

4. The method according to claim 3, wherein the vehicle functions configured to allocate the corresponding one of the memory portions provide a full shared memory implementation.

5. The method according to claim 2, wherein at least one of the vehicle functions that is configured to send the request registers for the memory allocation service with at least one of the vehicle functions that is configured to allocate the corresponding one of the memory portions.

6. The method according to claim 2, wherein all of the vehicle functions are configured to allocate the corresponding one of the memory portions and provide a full shared memory implementation.

7. The method according to claim 3, comprising, if two or more of the vehicle functions are registered simultaneously and each of the two or more of the vehicle functions is configured to allocate the memory portion, applying a prioritizing algorithm to determine a single dominating vehicle function that applies the allocation algorithm.

8. The method according to claim 7, wherein the prioritizing algorithm includes a ranking of the two or more of the vehicle, functions, starting with one of the vehicle functions that is most relevant for vehicle safety and/or security.

9. The method according to claim 8, wherein the ranking ends with at least one of the vehicle functions that is a pure convenience function.

10. The method according to claim 1, wherein a centralized software separate from the vehicle functions applies the allocation algorithm.

11. The method according to claim 10, wherein the centralized software determines non-continuous locations of the memory portions.

12. The method according to claim 10, wherein the centralized software determines continuous locations of the memory portions.

13. The method according to claim 12, wherein the size of each of the memory portions is determined dynamically based on a corresponding one of the vehicle functions.

14. The method according to claim 1, comprising, for each vehicle function of the vehicle functions, after the disconnecting the vehicle function from the memory allocation service, removing an allocation to the corresponding one of the memory portions of the shared memory.

15. The method according to claim 14, comprising, for each vehicle function of the vehicle functions, erasing all data stored in the corresponding one of the memory portions.

16. A vehicle comprising:
a processing device; and
a shared memory,
wherein each of a plurality of vehicle functions of the vehicle is configured to execute a corresponding one of a plurality of applications in a corresponding one of a plurality of memory portions of the shared memory, and
wherein the processing device includes:
a processor; and
a data storage storing instructions that, when executed by the processor, cause the processing device to:
for each vehicle function of the vehicle functions:
register the vehicle function for a memory allocation service;
determine a location and a size of the corresponding one of the memory portions of the shared memory for the vehicle function by applying an allocation algorithm;
execute the corresponding one of the applications of the vehicle function on the corresponding one of the memory portions; and
after the corresponding one of the applications of the vehicle function is executed, disconnect the vehicle function from the memory allocation service;
wherein the allocation algorithm allocates dynamically the corresponding one of the memory portions.

17. A non-transitory computer-readable medium storing instruction that, when executed by a processing device of a vehicle with a shared memory, cause the processing device to perform the method according to claim 1.

18. A processing device comprising:
a processor; and
a data storage storing instructions that, when executed by the processor, cause the processing device to:
for each vehicle function of a plurality of vehicle functions that is configured to execute a corresponding one of a plurality of applications in a corresponding one of a plurality of memory portions of a shared memory:
register the vehicle function for a memory allocation service;
determine a location and a size of the corresponding one of the memory portions of the shared memory for the vehicle function by applying an allocation algorithm;
execute the corresponding one of the applications of the vehicle function on the corresponding one of the memory portions; and
after the corresponding one of the applications of the vehicle function is executed, disconnect the vehicle function from the memory allocation service;
wherein the allocation algorithm allocates dynamically the corresponding one of the memory portions.
